(19) United States
(12) Patent Application Publication
(10) Pub. No.: US 2009/0085002 A1
(43) Pub. Date: Apr. 2, 2009

(54) METHOD OF MODIFYING SURFACE OF MAGNETIC POWDER AND MAGNETIC COATING MATERIAL

(75) Inventors: Kazufumi Omura, Kanagawa (JP); Tadahiro Ooishi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/238,837

(22) Filed: Sep. 26, 2008

(30) Foreign Application Priority Data
Sep. 28, 2007 (JP) 2007-256866

(51) Int. Cl. H01F 1/00

(52) U.S. Cl. 252/62.51 R

(57) ABSTRACT

An aspect of the present invention relates to a method of modifying a surface of a magnetic powder, comprising mixing a magnetic powder with a cyclic compound comprising at least one carboxylic group. A further aspect of the present invention relates to a magnetic coating material comprising a magnetic powder and a binder, further comprising a cyclic compound comprising at least one carboxylic group.

### CROSS-REFERENCE TO RELATED APPLICATIONS

This application claims the benefit of priority under 35 USC 119 to Japanese Patent Application No. 2007-256866 filed on Sep. 28, 2007, which is expressly incorporated herein by reference in its entirety.

### FIELD OF THE INVENTION

The present invention relates to a method of modifying a surface of a magnetic powder, more particularly, to a method of modifying a surface of a magnetic powder in a magnetic coating material capable of improving dispersibility of the magnetic powder.

The preset invention further relates to a magnetic coating material.

### DISCUSSION OF THE BACKGROUND

In recent years, means for rapidly transmitting information have undergone marked development, making it possible to transmit data and images comprising huge amounts of information. As data transmission technology has improved, the need for higher density recording in the recording media and recording and reproduction devices used to record, reproduce, and store information has developed.

In addition to using microgranular magnetic materials, it is known that dispersing microgranular magnetic materials to a high degree and increasing the smoothness of the magnetic layer surface are effective means of achieving good electromagnetic characteristics in the high-density recording region. A magnetic recording medium with a high degree of gloss can also be achieved by increasing the dispersibility of the magnetic material.

As described in Japanese Unexamined Patent Publication (KOKAI) No. 2003-132531 or English language family member US 2003/0143323 A1, for example, one widely employed means of increasing the dispersibility of the magnetic material is to incorporate a polar group such as SO₃Na into the binder. The contents of these applications are expressly incorporated herein by reference in their entirety. Phosphonic acid, phosphoric acids, and polyvalent carboxylic acids are also known additives that effectively enhance dispersion. Such additives are disclosed in, for example, Japanese Unexamined Patent Publication (KOKAI) Heisei No. 8-279142, which is expressly incorporated herein by reference in its entirety.

The introduction of a polar group into the binder is an effective means of improving dispersibility. However, the introduction of an excessively large quantity of polar groups into the binder runs the risk of diminishing dispersibility. Accordingly, it is conceivable to employ a dispersing agent. However, there is a risk of corroding metal heads with strong acids such as phosphonic acid and phosphoric acids. Further, the polyvalent carboxylic acids described in Japanese Unexamined Patent Publication (KOKAI) Heisei No. 8-279142 are strongly hydrophilic, presenting the problems of inadequate improvement of the surface of the ferromagnetic powder and diminished adsorption of binder.

### SUMMARY OF THE INVENTION

An aspect of the present invention provides for a means of modifying the surface of magnetic powder to increase the dispersibility of the magnetic powder in the magnetic coating material.

An aspect of the present invention relates to a method of modifying a surface of a magnetic powder, comprising mixing a magnetic powder with a cyclic compound comprising at least one carboxylic group.

The cyclic compound may be at least one cyclic compound selected from the group consisting of alicyclic compounds, aromatic compounds, and heterocyclic compounds.

The cyclic compound may comprise at least one cyclic structure selected the group consisting of a cyclohexane ring and a naphthalene ring.

The cyclic compound may comprise one carboxylic group per molecule.

The cyclic compound may be at least one cyclic compound selected from the group consisting of 1-naphthalenecarboxylic acid, 2-naphthalenecarboxylic acid, and cyclohexanecarboxylic acid.

The magnetic powder may be comprised in a magnetic coating material.

The surface of the magnetic powder may be modified to improve dispersibility of the magnetic powder in the magnetic coating material.

A further aspect of the present invention relates to a magnetic coating material comprising a magnetic powder and a binder, further comprising a cyclic compound comprising at least one carboxylic group.

The cyclic compound may be at least one cyclic compound selected from the group consisting of alicyclic compounds, aromatic compounds, and heterocyclic compounds.

The cyclic compound may comprise at least one cyclic structure selected the group consisting of a cyclohexane ring and a naphthalene ring.

The cyclic compound may comprise one carboxylic group per molecule.

The cyclic compound may be at least one cyclic compound selected from the group consisting of 1-naphthalenecarboxylic acid, 2-naphthalenecarboxylic acid, and cyclohexanecarboxylic acid.

The magnetic coating material may be a coating liquid for forming a magnetic layer of the magnetic recording medium.

According to the present invention, the dispersibility of magnetic powder in magnetic coating material can be improved by modifying the surface of the magnetic powder.

Other exemplary embodiments and advantages of the present invention may be ascertained by reviewing the present disclosure.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Method of Modifying Surface of Magnetic Powder

The present invention relates to a method of modifying a surface of a magnetic powder. The modifying method of the present invention comprises mixing a magnetic powder with a cyclic compound comprising at least one carboxylic group. The above cyclic compound can be employed singly or in combination of two or more.

The cyclic compound is thought to impart a hydrophobic property to the magnetic powder by adhering to the surface of the magnetic powder. Since the surface of magnetic powder has generally high hydrophilic property, hydrophobic binder components tend not to adsorb. Thus, the cyclic compound is thought to adhere to the surface of the magnetic powder, increasing the amount of adsorption of binder to the magnetic powder by intensifying the hydrophobic properties of the surface of the magnetic powder, thereby increasing the dispersibility of the magnetic powder in the magnetic coating material. For example, as will be shown in Examples described farther below, it is possible to confirm that the cyclic compound modifies the surface of the magnetic powder by the fact that the presence of the cyclic compound changes the amount of adsorption of binder to the magnetic powder in the magnetic coating material. The fact that the cyclic compound adheres to the surface of the magnetic powder can be confirmed by the fact that the concentration of the cyclic compound observed in the supernatant in the course of mixing the magnetic powder and the cyclic compound is lower than the concentration of the cyclic compound added.

The cyclic compound will be described in greater detail below.

### Cyclic Compound

The cyclic compound comprises at least one carboxyl group. The number of carboxyl groups per molecule of the cyclic compound is at least one, desirably 1 to 5, preferably 1 to 3, and more preferably, 1.

The cyclic compound that has adsorbed to the magnetic powder can be caused to further adsorb to the binder to improve the dispersibility of the magnetic powder in the magnetic coating material. Covering the magnetic powder to which the cyclic compound has adsorbed with binder can create a steric barrier, preventing aggregation of magnetic powders. Compounds capable of performing such function can be cyclic or chain-like in structure. However, the present inventors have discovered through investigation that cyclic compounds afford greater interaction with binder and adsorb better onto magnetic powder and binder than chain-like compounds. This is thought to be due to the significant interaction between the cyclic structure portion of the binder and the cyclic structure portions of cyclic compounds.

The cyclic structure comprised in the cyclic compound can be an aliphatic ring, aromatic ring, or heterocyclic ring. The cyclic structure may be that of a single ring or condensed ring. One or more cyclic structures can be contained per molecule, or the structure may be one in which different types of cyclic structures are linked by a linking group.

When the cyclic compound is an alicyclic compound, the cyclic structure contained within it is, for example, an optionally condensed ring having 5 to 30 carbon atoms, desirably an optionally condensed aliphatic ring having 5 to 10 carbon atoms, and preferably, a cyclohexane ring.

When the cyclic compound is an aromatic compound, the aromatic ring contained within it is desirably a five-membered, six-membered, or seven-membered ring, or a condensed ring formed by such a ring; preferably a five-membered or six-membered ring; and more preferably, a six-membered ring. Specific examples are benzene, naphthalene, anthracene, and phenanthrene rings, with a naphthalene ring being preferred.

When the cyclic compound is a heterocyclic compound, examples of the hetero atoms contained in the hetero ring are nitrogen, oxygen, and sulfur atoms. Nitrogen atoms are desirable. The heterocyclic ring, for example, comprises 1 to 30 carbon atoms, desirably 1 to 20 carbon atoms, and preferably, 1 to 12 carbon atoms. Specific examples of such hetero rings are: pyrrole, pyrazole, imidazole, pyridine, furan, thiophene, oxazole, and thiazole rings; benzo-condensed products thereof; and hetero ring-condensed products thereof. A pyridine ring is desirable as the hetero ring.

The cyclic compound can comprise one or more substituents in addition to the carboxyl group. Examples of such substituents are halogen atoms (for example, fluorine, chlorine, bromine, and iodine atoms), cyano groups, nitro groups, alkyl groups having 1 to 16 carbon atoms, alkenyl groups having 1 to 16 carbon atoms, alkynyl groups having 2 to 16 carbon atoms, halogen-substituted alkyl groups having 1 to 16 carbon atoms, alkoxy groups having 1 to 16 carbon atoms, acyl groups having 2 to 16 carbon atoms, alkylthio groups having 1 to 16 carbon atoms, acyloxy groups having 2 to 16 carbon atoms, alkoxycarbonyl groups having 2 to 16 carbon atoms, carbamoyl groups, alkyl-substituted carbamoyl groups having 2 to 16 carbon atoms, and acylamino groups having 2 to 16 carbon atoms. The substituent is desirably a halogen atom, cyano group, alkyl group having 1 to 6 carbon atoms, halogen-substituted alkyl group having 1 to 6 carbon atoms; preferably a halogen atom, alkyl group having 1 to 4 carbon atoms, or halogen-substituted alkyl group having 1 to 4 carbon atoms; and more preferably, a halogen atom, alkyl group having 1 to 3 carbon atoms, or trifluoromethyl group.

Desirable specific examples of the cyclic compound are 1-naphthalenecarboxylic acid, 2-naphthalenecarboxylic acid, and cyclohexanecarboxylic acid.

The cyclic compound can be readily synthesized by known methods, and may be commercially available.

The quantity of cyclic compound employed relative to the magnetic powder can be suitably set. However, the addition of an excessive quantity of the cyclic compound to the coating liquid for forming a magnetic layer of a magnetic recording medium is undesirable because the coating sometimes plasticizes or separates. From this perspective, the quantity of cyclic compound employed is desirably 0.1 to 10 weight parts, preferably 2 to 8 weight parts, per 100 weight parts of the magnetic powder. Methods of mixing the cyclic compound and the magnetic powder will be described further below.

The cyclic compound can increase the dispersibility of the magnetic powder in the magnetic coating material by modifying the surface of the magnetic powder. Accordingly, the above cyclic compound is desirably employed as a dispersing agent for magnetic coating materials.

### Magnetic Coating Material

The magnetic coating material of the present invention comprises a magnetic powder, a binder and a cyclic compound comprising at least one carboxylic group. In the magnetic coating material of the present invention, the above cyclic compound can improve adsorption of the binder to the magnetic powder, permitting a higher degree of dispersion of the magnetic powder. The details of the above cyclic compound are as set forth above.

The various components of the magnetic coating material of the present invention will be described below.

### Magnetic Powder

Ferromagnetic powders that are commonly incorporated into the coating liquid for forming a magnetic layer of magnetic recording medium can be employed as the magnetic powder. Desirable examples of such ferromagnetic powders are ferromagnetic hexagonal ferrite powders and ferromagnetic metal powders.

### (i) Hexagonal Ferrite Powder

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

As the hexagonal ferrite powder, those having an average plate diameter ranging from 10 to 50 nm are desirably employed. The average plate diameter preferably ranges from 15 to 40 nm, more preferably 15 to 30 nm. According to the present invention, the dispersibility of microgranular hexagonal ferrite powders such as those with the above-described average plate diameter can be improved.

An average plate ratio [arithmetic average of (plate diameter/plate thickness)] preferably ranges from 1 to 15, more preferably 1 to 7. When the average plate diameter ranges from 1 to 15, adequate orientation can be achieved while maintaining high filling property, as well as increased noise due to stacking between particles can be suppressed. The specific surface area by BET method (S_{BET}) within the above particle size range is preferably equal to or higher than 40 m²/g, more preferably 40 to 200 m²/g, and particularly preferably, 60 to 100 m²/g.

Narrow distributions of particle plate diameter and plate thickness of the hexagonal ferrite powder are normally good. About 500 particles can be randomly measured in a transmission electron microscope (TEM) photograph of particles to measure the particle plate diameter and plate thickness, as set forth above. The distributions of particle plate diameter and plate thickness are often not a normal distribution. However, when expressed as the standard deviation to the average size, c/average size may be 0.1 to 1.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known. The pH of the hexagonal ferrite powder is normally about 4 to 12 and usually optimum for the dispersion medium and polymer. From the perspective of the chemical stability and storage properties in the medium, a pH of about 6 to 11 can be selected. Moisture contained in the hexagonal ferrite powder also affects dispersion. The moisture content is usually optimum for the dispersion medium and polymer, normally within a range of 0.01 to 2.0.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention. As needed, the hexagonal ferrite powder can be surface treated with Al, Si, P, or an oxide thereof. The quantity can be set to 0.1 to 10 weight percent of the hexagonal ferrite powder. When applying a surface treatment, the quantity of a lubricant such as a fatty acid that is adsorbed is desirably not greater than 100 mg/m². The hexagonal ferrite powder will sometimes contain inorganic ions such as soluble Na, Ca, Fe, Ni, or Sr. These are desirably substantially not present, but seldom affect characteristics at equal to or less than 200 ppm.

### (ii) Ferromagnetic Metal Powder

The ferromagnetic metal powder employed is not specifically limited, but preferably a ferromagnetic metal power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Any one from among the known method of slow oxidation, that is, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film, may be employed.

The specific surface area by BET method of the ferromagnetic metal powder employed is preferably 45 to 100 m²/g, more preferably 50 to 80 m²/g. At 45 m²/g and above, low noise can be achieved. At 100 m²/g and below, good surface properties can be achieved. The crystallite size of the ferromagnetic metal powder is preferably 40 to 180 Angstroms, more preferably 40 to 150 Angstroms, and still more preferably, 40 to 110 Angstroms. The average major axis length (average particle size) of the ferromagnetic metal powder preferably ranges from 10 to 50 nm, more preferably 10 to 40 nm, and further preferably 15 to 30 nm. According to the present invention, the dispersibility of microgranular ferromagnetic metal powders such as those with the above-described average major axis length can be improved. The acicular ratio of the ferromagnetic metal powder is preferably equal to or greater than 3 and equal to or less than 15, more preferably equal to or greater than 3 and equal to or less than 12.

The moisture content of the ferromagnetic metal powder preferably ranges from 0.01 to 2 weight percent. The moisture content of the ferromagnetic metal powder is desirably optimized based on the type of binder. The pH of the ferromagnetic metal powder is desirably optimized depending on what is combined with the binder. A range of 4 to 12 can be established, with 6 to 10 being preferred. As needed, the ferromagnetic metal powder can be surface treated with Al, Si, P, or an oxide thereof. The quantity can be set to 0.1 to 10 weight percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present, but seldom affect characteristics at equal to or less than 200 ppm. The ferromagnetic metal powder employed in the present invention desirably has few voids; the level is preferably equal to or less than 20 volume percent, more preferably equal to or less than 5 volume percent. As stated above, so long as the particle size characteristics are satisfied, the ferromagnetic metal powder may be acicular, rice grain-shaped, or spindle-shaped. Binder

Conventionally known thermoplastic resins, thermosetting resins, reactive resins and mixtures thereof may be employed as binders used. The thermoplastic resins suitable for use have a glass transition temperature of −100 to 150° C., a number average molecular weight of 1,000 to 200,000, preferably from 10,000 to 100,000, and have a degree of polymerization of about 50 to 1,000.

Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten, which is expressly incorporated herein by reference in its entirety. It is also possible to employ known electron beam-cured resins. Examples and manufacturing methods of such resins are described in Japanese Unexamined Patent Publication (KOKAI) Showa No. 62-256219, which is expressly incorporated herein by reference in its entirety. The above-listed resins may be used singly or in combination. Preferred resins are combinations of polyurethane resin and at least one member selected from the group consisting of vinyl chloride resin, vinyl chloride-vinyl acetate copolymers, vinyl chloride-vinyl acetate-vinyl alcohol copolymers, and vinyl chloride-vinyl acetate-maleic anhydride copolymers, as well as combinations of the same with polyisocyanate. Resins suitable for use as binder can be synthesized by known methods, and may be commercially available.

Known polyurethane resins may be employed, such as polyester polyurethane, polyether polyurethane, polyether polyester polyurethane, polycarbonate polyurethane, polyester polycarbonate polyurethane, and polycaprolactone polyurethane. A binder obtained by incorporating as needed one or more polar groups selected from among —COOM, —SO₃M, —OSO₃M, —P═O(OM)₂, and —O—P═O(OM)₂ (where M denotes a hydrogen atom or an alkali metal base), —OH, —NR₂, —N⁺R₃ (where R denotes a hydrocarbon group), epoxy group, —SH, and —CN into any of the above-listed binders by copolymerization or addition reaction to improve dispersion properties and durability is desirably employed. The quantity of such a polar group ranges from 10⁻¹ to 10⁻⁸ mol/g, preferably from 10⁻² to 10⁻⁶ mol/g. In particular, the above-described cyclic compound is preferably employed together with the sulfonic acid group-containing binder.

The quantity of binder added to the magnetic coating material of the present invention ranges from, for example, 5 to 50 weight percent, preferably from 10 to 30 weight percent, relative to the weight of the magnetic powder. When employing vinyl chloride resin, the quantity of binder added is preferably from 5 to 30 weight percent; when employing polyurethane resin, from 2 to 20 weight percent; and when employing polyisocyanate, from 2 to 20 weight percent. They may be employed in combination. However, for example, when head corrosion occurs due to the release of trace amounts of chlorine, polyurethane alone or just polyurethane and isocyanate may be employed.

Examples of polyisocyanates are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These polyisocyanates can be synthesized by known methods, and may be commercially available.

In addition to the above-described cyclic compound, magnetic powder and binder, the magnetic coating material of the present invention can comprise one or more additives normally employed in the coating liquid for forming a magnetic layer of a magnetic recording medium, such as abrasives, lubricants, antifungal agents, antistatic agents, oxidation inhibitors, solvents, and carbon black.

The magnetic coating material of the present invention can be prepared by mixing the above-described cyclic compound, magnetic powder, binder, and additives as needed. Specifically, it can be prepared by the method normally employed for the preparation of the coating liquid of magnetic layer. The preparation process comprises, for example, a kneading step, a dispersing step, and a mixing step to be carried out, if necessary, before and/or after the kneading and dispersing steps. Each of the individual steps may be divided into two or more stages. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the magnetic material, with a dispersing medium with a high specific gravity such as zirconia beads, titania beads, and steel beads being suitable for use. The particle diameter and fill ratio of these dispersing media can be optimized for use. A known dispersing device may be employed.

For the addition of the above-described cyclic compound to be effective, the cyclic compound is desirably present at the stage where the magnetic powder and binder are brought into contact. This is to prevent the binder from contacting the surface of the magnetic powder before the cyclic compound has adhered to the surface of the magnetic powder. Accordingly, the magnetic coating material of the present invention is desirably prepared by simultaneously mixing the magnetic powder, the binder and the cyclic compound, or by mixing the magnetic powder and the cyclic compound to obtain a mixture and then mixing the binder to the mixture.

The above components are desirably specifically mixed by the following methods:
(1) The magnetic powder and the cyclic compound are dry dispersed for about 15 to 30 minutes in advance, and then added to an organic solvent. The binder can be simultaneously added with the dispersion, or can be added after the dispersion.
(2) The magnetic powder and the cyclic compound are dispersed for about 15 to 30 minutes in an organic solvent, and then dried. The dry mixture is suitably comminuted and then added to an organic solvent. The binder can be simultaneously added with the mixture, or added after the mixture.
(3) The magnetic powder and the cyclic compound are dispersed for about 15 to 30 minutes in an organic solvent, after which the binder B is added.
(4) The magnetic powder, the cyclic compound and the binder are simultaneously added to an organic solvent and dispersed.

Known organic solvents can be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane. These organic solvents need not be 100 weight percent pure and may contain impurities such as isomers, unreacted materials, by-products, decomposition products, oxides and moisture in addition to the main components. The content of these impurities is preferably equal to or less than 30 weight percent, more preferably equal to or less than 10 weight percent. To improve dispersibility, a solvent having a somewhat strong polarity is desirable. It is desirable that solvents having a dielectric constant equal to or higher than 15 are comprised equal to or higher than 50 percent of the solvent composition. Further, the dissolution parameter is desirably 8 to 11.

Since magnetic powders can be dispersed with high dispersibility in the magnetic coating material of the present invention, the magnetic coating material of the present invention can be suitably employed as a coating liquid for forming a magnetic layer of the magnetic recording medium, for which high dispersibility is required.

### EXAMPLES

The present invention will be described in detail below based on examples. However, the present invention is not limited to the examples.

### Example 1

A suspension was prepared from 2.2 weight parts of the ferromagnetic hexagonal ferrite powder indicated below, 1 weigh part of sulfonic acid group-containing polyurethane (sulfonic acid group content: 3.3×10⁴ mol/g), and 0.13 weight part of 1-naphthalenecarboxylic acid in a solution comprised of 3.3 weight parts of cyclohexanone and 4.9 weight parts of 2-butanone. Twenty-seven weight parts of zirconia beads (made by Nikkato) were added to the suspension and the mixture was dispersed for 6 hours. The ratio of the polyurethane on the surface of the ferromagnetic hexagonal ferrite powder dispersed in the solution to the polyurethane in the solution was 9.2/1 as measured by the method set forth further below. Ferromagnetic hexagonal barium ferrite powder

Composition other than oxygen (molar ratio): Ba/Fe/Co/Zn=1/9/0.2/1

Hc: 176 kA/m (approximately 2200 Oe)

Average plate diameter: 25 nm

Average plate ratio: 3

Specific surface area by BET method: 65 m²/g

σs: 49 A·m²/kg (approximately 49 emu/g)

pH: 7

### Example 2

A suspension was prepared from 2.2 weight parts of the same ferromagnetic hexagonal ferrite powder as in Example 1, 1 weight part of the same polyurethane as in Example 1, and 0.09 weight parts of cyclohexanecarboxylic acid in a solution comprised of 3.3 weight parts of cyclohexanone and 4.9 parts 2-butanone. Twenty-seven weight parts of zirconia beads (made by Nikkato) were added to the suspension and the mixture was dispersed for 6 hours. The ratio of the polyurethane on the surface of the ferromagnetic hexagonal ferrite powder dispersed in the solution to the polyurethane in the solution was 9.5/1 as measured by the method set forth further below.

### Example 3

A suspension was prepared from 8.0 weight parts of the same ferromagnetic hexagonal ferrite powder as in Example 1 and 0.13 weight part of 1-naphthalene-carboxylic acid in a solution comprised of 3.3 weight parts of cyclohexanone and 4.9 weight parts of 2-butanone. Twenty-seven weight parts of zirconia beads (made by Nikkato) were added to the suspension and the mixture was dispersed for 6 hours. The 1-naphthalenecarboxylic acid in the dispersion as measured by acid-base titration was below the detection threshold. As a result, the 1-naphthalenecarboxylic acid was determined to have adsorbed onto the surface of the ferromagnetic hexagonal ferrite powder.

### Example 4

A suspension was prepared from 5.0 weight parts of the same ferromagnetic hexagonal ferrite as in Example 1 and 0.09 weight part of cyclohexanecarboxylic acid in a solution comprised of 3.3 weight parts of cyclohexanone and 4.9 weight parts of 2-butanone. Twenty-seven weight parts of zirconia beads (made by Nikkato) were added to the suspension and the mixture was dispersed for 6 hours. The cyclohexanecarboxylic acid in the dispersion as measured by acid-base titration was below the detection threshold. As a result, the cyclohexanecarboxylic acid was determined to have adsorbed onto the surface of the ferromagnetic hexagonal ferrite powder.

### Comparative Example 1

A suspension was prepared from 2.2 weight parts of the same ferromagnetic hexagonal ferrite powder as in Example 1, 1 weight part of the same polyurethane as in Example 1, and 0.15 weight part of citric acid in a solution comprised of 3.3 weight parts of cyclohexanone and 4.9 weight parts of 2-butanone. Twenty-seven weight parts of zirconia beads (made by Nikkato) were added to the suspension and the mixture was dispersed for 6 hours. The ratio of the polyurethane on the surface of the ferromagnetic hexagonal ferrite powder dispersed in the solution to the polyurethane in the solution was 4.6/1 as measured by the method set forth further below.

### Comparative Example 2

A suspension was prepared from 2.2 weight parts of the same ferromagnetic hexagonal ferrite powder as in Example 1, 1 weight part of the same polyurethane as in Example 1, and 0.13 weight part of phthalic acid in a solution comprised of 3.3 weight parts of cyclohexanone and 4.9 weight parts of 2-butanone. Twenty-seven weight parts of zirconia beads (made by Nikkato) were added to the suspension and the mixture was dispersed for 6 hours. The ratio of the polyurethane on the surface of the ferromagnetic hexagonal ferrite powder dispersed in the solution to the polyurethane in the solution was 2.6/1 as measured by the method set forth further below.

### Comparative Example 3

A suspension was prepared from B 2.2 weight parts of the same ferromagnetic hexagonal ferrite powder as in Example 1 and 1 weight part of the same polyurethane as in Example 1 in a solution comprised of 3.3 weight parts of cyclohexanone and 4.9 weight parts of 2-butanone. Twenty-seven weight parts of zirconia beads (made by Nikkato) were added to the suspension and the mixture was dispersed for 6 hours. The ratio of the polyurethane on the surface of the ferromagnetic hexagonal ferrite powder dispersed in the solution to the polyurethane in the solution was 4.0/1 as measured by the method set forth further below.

### Method of Measuring the Ratio of Polyurethane Present

A compact separation ultracentrifuge, the CS150GXL made by Hitachi, was used to centrifugally separate the ferromagnetic hexagonal ferrite powder and the solution for 80 minutes at 100,000 rpm. A 3 mL quantity of the supernatant was measured out and weighed. The supernatant was dried at 40° C. for 18 hours and then under vacuum at 140° C. for 3 hours. The weight of the dried mixture was adopted as the solid component of unadsorbed binder and used to calculate the ratio of binder on the surface of the ferromagnetic powder surface to that in the solution.

The ratio of polyurethane on the surface of the ferromagnetic hexagonal powder was higher in Examples 1 and 2 than in Comparative Examples 1 to 3. This result indicated that the surface of the magnetic powder was modified by the cyclic compound employed, enhancing adsorption to the polyurethane.

According to the present invention, dispersibility of the magnetic powder can be improved.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A method of modifying a surface of a magnetic powder, comprising mixing a magnetic powder with a cyclic compound comprising at least one carboxylic group.

2. The method of modifying a surface of a magnetic powder according to claim 1, wherein the cyclic compound is at least one cyclic compound selected from the group consisting of alicyclic compounds, aromatic compounds, and heterocyclic compounds.

3. The method of modifying a surface of a magnetic powder according to claim 1, wherein the cyclic compound comprises at least one cyclic structure selected the group consisting of a cyclohexane ring and a naphthalene ring.

4. The method of modifying a surface of a magnetic powder according to claim 1, wherein the cyclic compound comprises one carboxylic group per molecule.

5. The method of modifying a surface of a magnetic powder according to claim 1, wherein the cyclic compound is at least one cyclic compound selected from the group consisting of 1-naphthalenecarboxylic acid, 2-naphthalenecarboxylic acid, and cyclohexanecarboxylic acid.

6. The method of modifying a surface of a magnetic powder according to claim 1, wherein the magnetic powder is comprised in a magnetic coating material.

7. The method of modifying a surface of a magnetic powder according to claim 6, wherein the surface of the magnetic powder is modified to improve dispersibility of the magnetic powder in the magnetic coating material.

8. A magnetic coating material comprising a magnetic powder and a binder, further comprising a cyclic compound comprising at least one carboxylic group.

9. The magnetic coating material according to claim 8, wherein the cyclic compound is at least one cyclic compound selected from the group consisting of alicyclic compounds, aromatic compounds, and heterocyclic compounds.

10. The magnetic coating material according to claim 8, wherein the cyclic compound comprises at least one cyclic structure selected the group consisting of a cyclohexane ring and a naphthalene ring.

11. The magnetic coating material according to claim 8, wherein the cyclic compound comprises one carboxylic group per molecule.

12. The magnetic coating material according to claim 8, wherein the cyclic compound is at least one cyclic compound selected from the group consisting of 1-naphthalenecarboxylic acid, 2-naphthalenecarboxylic acid, and cyclohexanecarboxylic acid.

13. The magnetic coating material according to claim 8, which is a coating liquid for forming a magnetic layer of a magnetic recording medium.
